(19) United States
(12) Patent Application Publication
(10) Pub. No.: US 2005/0108419 A1
(43) Pub. Date: May 19, 2005

(54) Multicast peering

(76) Inventor: Thomas Marshall Eubanks, Clifton, VA (US)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 10/869,048

(22) Filed: Jun. 17, 2004

Related U.S. Application Data
(63) Continuation of application No. 09/595,013, filed on Jun. 16, 2000, now abandoned.

(51) Int. Cl. G06F 15/16

(52) U.S. Cl. 709/232

(57) ABSTRACT

Multicast peering in commercial Internets is performed by a trusted third party which has a connection into two or more Autonomous Systems. Multicast streams pass from the trusted third party into the Autonomous Systems independently. There is thus no need for any sharing of information between the Autonomous Systems, with any information sharing taking place only between each Autonomous System and the trusted third party.

### BACKGROUND OF THE INVENTION

An Internet is a packet switched network of computers and local networks consisting of nodes, which can be computers or networks of computers, routers, and data transmission lines, with the routers being used to route packets over data transmission lines towards the intended recipient. All information on an Internet is conveyed encapsulated in packets, which consist of a header (containing routing and other information) and a body for containing data. Generally data transfers on an Internet consist of more information than can be conveyed in one packet, with a data transmission thereby consisting of a set of related packets being sent from one source to one receiver. A data transmission consisting of time ordered data, such as with an audio or video broadcast, is called a stream. Data transmissions on an Intemet uses Internet Protocol (IP) standards based on protocols standardized by the Internet Engineering Task Force (IETF). Each node and router reachable in an Internet is assigned an Internet address, and routers maintain information about how to reach any of a variety of Internet addresses. A transmission of packets from one router to the next in the chain lending to the final destination is called a “hop”.

Unless a source and a receiver are directly connected, Internet transmissions of data will pass through at least one, and in general many, routers between leaving the source and arriving at the receiver. These routers can use one of several routing protocols, which describe both the creation and storage in any particular router of information about how packets should be forwarded to reach any particular destination, a means of sharing this information between routers, and other details about the forwarding of packets. Routing protocols also generally include adjustable parameters, describing such features as possible data transmission rates and the timing of various actions, which can be set by the owner or operator of the router based on various considerations. The choice of a particular set of parameter values in a given routing protocol is referred to as the router configuration. In addition, routers from specific vendors may or may not support all routing protocols, or all possible choices of router configuration.

IP data transmissions can be one to one (or unicasting), one to all (or broadcasting), one to many or many to many, with the last two possibilities being described as multicasting. Multicasting is more specifically a means of the sending of packets from one or more sources to one or more receivers, in such as way as only one copy of each packet is required to leave any source and the packets are multiplied as required by routers in the Internet to reach the desired receivers. Unicasting, multicasting and broadcasting of packets are all performed using specific routing protocols, and one router may use different routing protocols for each of these different transmission methods.

Broadcasting of packets is used for signaling and notification only, being explicitly confined to only the neighboring nodes and routers of the transmitters, with routers being forbidden to forward broadcast packets to other routers. Actual data transfers on an Internet thereby are conducted using unicasting or multicasting.

Multicast data transfers on an Internet are transmitted from a particular source, with a related set of transmissions being called a multicast group. There must be at least one source per group, and any particular source can only belong to one particular multicast group.

Any given node on an Internet can be a source for one or more groups; the number of sources that a node can support being restricted only by hardware or software limitations at the node, although each source in a group must have a unique Internet address.

In order to perform multicasting on an Internet, it is necessary to construct a multicast tree. In general, each source for each group must have a separate tree, but it is possible for sources for one group to share part or all of their trees, creating a shared tree. There is no central control in multicast routing; a tree is constructed by the routers and consists of a table maintained by each router, with said table containing the name of the group, a list of sources (for source specific trees), the direction of the source (i.e., the location of the source, or of the next router along the tree to the source), and the direction to any receivers of the group traffic, with each receiver being assumed to be interested in all of the source transmissions for some group.

The existence of these tables within a router is called router state. Unlike the case in unicasting, multicast transmission or reception changes the router state, through the additions of new multicast groups, sources, or receivers. Changes in router state can be a major cause of resource expenditure by a network, with excessively frequent changes, or excessively large router tables, the potential to seriously degrade network performance.

Multicast routing protocols are classified as “sparse mode” or “dense mode”, In sparse mode, reception of a multicast transmission by a receiver is accomplished by a multicast join, which is a message sent from the receiver to the nearest router (the so called “first hop router”), requesting the transmission. If the router is already part of the multicast tree and is already receiving the transmission, then the transmission is simply routed to the new receiver. If not, the router sends a join message to the next router in the chain going to either the source (if known) or a rendezvous point (RP, also called a Core), if the location of the source is not known. The join request travels towards the source or the RP, either a router is reached that is already receiving the multicast transmissions, or until the source or the RP is reached. In sparse mode a receiver stops receiving a multicast transmission (i.e., leaves the multicast group), by sending a “prune” message to the first hop router, which then ceases forwarding transmissions to the receiver. Multicast state in the routers is always subject to timers, and required periodic refreshing to remain valid; because of this it is also possible to stop receiving multicast transmissions by remaining silent, and thus to “time out”. In either case, each router in the tree, if it is no longer forwarding the multicast transmission to any receiver, will itself send a prune message to next router in the tree to be removed from the tree entirely.

In dense mode multicasting, which is an older and less capable technology, multicast packets are initially flooded to all possible receivers (the “flood” stage), which then have to explicitly prune themselves if they are not interested in receiving the transmissions (the “prune” stage). This “flood and prune” technique, although technically easy to implement, and is used on small Internets, or small subsets of large Internets, is not suited for deployment on arbitrarily large Internets due to the geometrical multiplication of the data transmissions required during the initial flood stage.

Although all of the routers in an Internet can use the same routing protocols with identical router configurations, in general routers in an Internet are owned and/or controlled by a number of entities, and it is common for there to be different routing protocols and routing configurations chosen for business or technical reasons by different router operators in an Internet. As it can be difficult or impossible to transmit packets between routers using different protocols, or with the same protocol but with different configurations, it is common to divide an Intemet into so-called Autonomous Systems, with each Autonomous System being a set of routers, networks and nodes managed as one administrative unit, using either one routing protocol and configuration, or a compatible set of routing protocols and/or configurations, i.e., one routing policy. In general, the routers in a given Autonomous System are given sufficient information to be able to route a packet to any Internet address contained within the Autonomous System.

Unicast transmissions of data between Autonomous Systems are done through the use of specially chosen routers known as Border Routers, or BRs, with a Border Gateway Protocol (BGP) to facilitate the exchange of unicast routing information between different Autonomous Systems. Using these protocols, a BR in one Autonomous System can discover whether a node address exists in another Autonomous System and details on unicast routing to that other node address in the other Autonomous System.

In general, routing of packets in an Internet is subject to business arrangements and must be accounted and paid for. Since the boundaries between Autonomous Systems generally coincide with a boundary between different Service Providers, unicast transmissions over Border Routers are generally accounted for and used as part of the calculations of the payments owed by one service provider to another. Since the operators of two Autonomous Systems can both account for the traffic at any Border Routers between the two systems, each can audit the unicast transmissions between their Autonomous Systems, and there is no need, in the unicast case, for intrusive audit arrangements between competitive Service Providers. The set of arrangements allowing for unicast transmissions between independent Service Providers is called unicast peering, or simply peering.

The large scale use of multicasting on Internets with more than one Autonomous Systems is currently hindered by the technical and business difficulties of conveying multicast transmissions over the boundaries between Autonomous Systems.

There is currently a lack of multicast peering on commercial Internets, because of business and commercial problems associated with such multicast peering. In multicasting, a single packet stream might cross a Border Router from an Autonomous System One (AS1) into an Autonomous System Two (AS2), and there be multiplied into many separate streams. Accounting for this multicast traffic, so that AS1 can properly pay AS2 for the work entailed by this transmission, would thus require detailed knowledge of the internal traffic within AS2, and this might reveal proprietary information about AS2. An audit of this accounting could not be done without intrusive monitoring of conditions within AS2, which would also reveal sensitive and proprietary information about the workings of AS1, AS2.

There are various technical problems at present with inter domain multicast routing. Multicast transmissions are sent to a multicast group, which consist of one or more receivers, from a source. If multicast traffic is allowed freely from the border routers of AS1 to those of AS2, there is no mechanism to prevent any source in AS1 from sending traffic to the multicast group in AS2. Unauthorized sources in AS1 could thus flood multicast group members in AS2 with unwanted packets, possibly disrupting the reception of intended data transmissions, thereby constituting a Denial of Service Attack on AS2.

A technical solution under development to solve some, but not all, of the problems associated with multicasting to multiple Autonomous Systems is called single source multicasting (SSM, or also PIM-Source only, or PIM-SO). In SSM, each multicast group is allowed to have only one, specific, source, associated with a specific Internet address. This alleviates the problems associated with unauthorized sources flooding an Autonomous System with multicast packets, however, it does not solve the business problems associated with accounting and managing multicast traffic across multiple Autonomous Systems. SSM is also efficient for solutions where there are multiple multicast sources emanating from one IP address, in that there has to be a separate multicast tree maintained for each such source. It is also possible that there would be three or more Autonomous Systems involved in a multicast transmission, say AS1, AS2 and AS3 In this situation, all sources might be located in AS1 and all receivers in AS3 but AS2 might be essential in the construction of the multicast tree between AS1 and AS3 AS2 is thus forced with performing work for which it has no customers, and thus no commercial reason to perform. This problem is called a “third party dependency” in the literature.

### SUMMARY OF THE INVENTION

The solution to the lack of multicast peering in commercial Internets that is the subject of the present invention is to perform -multicast peering with a trusted third party. In this solution, the trusted third party has a connection into both Autonomous System One and Autonomous System Two. Multicast streams pass from the trusted third party into both Autonomous Systems independently. There is thus no need for any sharing of information between Autonomous System One and Autonomous System Two, with any information sharing taking place only between each Autonomous System and the trusted third party.

The inventive trusted third party solution also solves various technical problems associated with multicast transmissions between different Autonomous Systems.

In the present invention, for example, the problem associated with maintaining separate multicast trees for each source, is solved because multicast trees can be shared by all such sources, reducing the amount of information that has to be maintained by each router in the multicast tree.

In the trusted third party solution, any multicast packets entering into two Autonomous Systems, AS1 and AS2, come only from the Trusted Third Party (TTP), which can control any multicast transmissions into each Autonomous System. There is no possibility of a malicious or unintended transfer of multicast transmissions from an arbitrary location in another Autonomous System. If for some reason the amount of multicast transmissions from TTP becomes too large, the trusted third party transmissions come from a known location, and can be. restricted or terminated by the network operators.

Third party dependencies are avoided in the trusted third party solution, as there are contractual relationships between TTP and each Autonomous System that participates in the multicast transmissions.

In a particularly advantageous embodiment of the invention, Staggered Erasure Correction (SEC) which is designed to deal with the time-correlated nature of actual packet loss, is used by TTP.

In yet another particularly advantageous embodiment of the invention, TTP is set up to prevent unauthorized sources from transmitting data on the TTPN through the use of a Multicast Firewall.

### BRIEF DESCRIPTION OF THE DRAWINGS

FIG. 1 is a block diagram which illustrates an implementation of a business model for multicast peering in accordance with an embodiment of the present invention.

### DETAILED DESCRIPTION OF THE PREFERRED EMBODIMENTS OF THE INVENTION

In a preferred implementation of the business model in accordance with the present invention, a dedicated-to-many transmission of multicast packets from one location to unlimited numbers of receivers is created using the Protocol Independent Multicast—Sparse Mode version 2 (PIM-SM v.2), with a co-located and restricted Rendezvous Point (RP), located at the TTP facility. Transmissions will consist of a number of separate channels, with each channel itself consisting of a number of separate sub-channels. In initial operations, each TTP channel will consist of 4 separate sub-channels, in order to provide the necessary information for the Staggered Erasure Correction (SEC), which is described in detail subsequently, and to provide for auxiliary text and computer control information. The delivery of information in a TTP channel shall be referred to as a stream, where it is implicitly understood that this stream consists of separate sub-streams, one for each of the sub-channels. The facilities and contractual relationships needed to perform these transmissions will, in aggregate, be called the Trusted Third Party Network (TTPN).

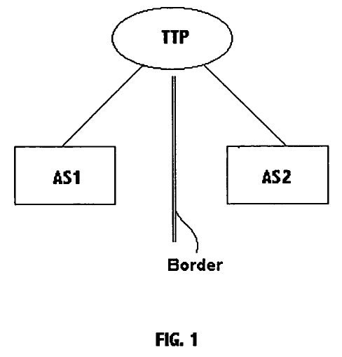

FIG. 1 is a block diagram which illustrates a trusted third party solution, wherein any multicast packets entering into two Autonomous Systems, AS1 and AS2, come from the Trusted Third Party (TTP) rather than as cross-border traffic between AS1 and AS2. In such an implementation, TTP can control any multicast transmissions into each Autonomous System, AS1 and AS2.

Multicast groups will be created for each separate TTP stream, with each multicast group consisting of a number of separate sources, one source for each sub-stream created for each sub-channel. TTP will host a group specific RP for these groups, and only for these groups, and these groups will not be advertised for other RP's in the Autonomous Systems with which TTP has a contractual relationship. In PIM-SM v.2, multicast packet delivery starts out using a shared tree rooted at the RP, which is a Shortest Path Tree (SPT) for the RP, but is not an SPT for a arbitrarily located source. In PIM-SM v.2, when data transmissions cross a specified threshold data rate for a particular group, that group is transferred to a SPT for each source in that group. This transfer is done at the router where the SPT for the RP and the SPT for the source diverge. In the TTPN, the sources are at the RP, so this transfer will not occur. This offers the advantage of both the Shortest Path Tree and the reduction in router state provided by use of a Core Based Tree.

It is generally thought that not switching to a SPT for each source is not good practice, and, indeed, in the commodity Internet the general practice is to set the threshold to zero, so that the transfer to the source based SPT occurs immediately. This is done to avoid having a “hot spot” at the RP, which would have to handle the routing for all sources in the group, and to keep the multicast traffic exclusively on SPTs. In the case of the one-to-many static transmissions on the TTPN, these benefits are illusory, as all traffic will use a SPT, and because some router would have to be the first hop router for the TTPN traffic, and would thus have to accommodate all of the TTPN traffic.

In yet another embodiment of the invention, TTP is set up to prevent unauthorized sources from transmitting data on the TTPN through the use of a Multicast Firewall as follows.

The only way to initiate, terminate or modify a multicast transmission in PIM-SM v.2 is through
reception of a PIM register message at the RP (used to register a new source and begin transmissions)
reception of a PIM register-stop message at the RP (used to stop transmissions from a source)
Reception of a IGMP v.2 membership report which mentions a new source or group
Reception of PIM join/leave messages (these apply only to multicast receivers, not to sources).
Reception of unexpected multicast traffic,
   The multicast firewall will protect the TTPN RP router from unauthorized state changes by
Rejection of PIM register and register-stop message from outside the TTPN facility,
Rejection of IGMP v.2 membership reports which refer to multicast groups or sources not used by the TTPN.
Reception of PIM join/leave messages which refer to multicast groups or sources not used by the TTPN.
Multicast traffic from outside (i.e., all multicast traffic flows outward only).
   The use of this multicast firewall will thus protect against unauthorized transmissions from the TTPN facilities (including transmissions from elsewhere that would then immediately be switched to a SPT not using the TTPN RP), as well as unauthorized termination of the TTPN transmissions.

In yet another embodiment of the invention, TTP will employ Staggered Erasure Correction (SEC) in order to ensure quality transmissions. SEC is described as follows.

The Internet is a “best-effort” packet transmission service, where there is no guarantee that a particular packet will be delivered, or that packet streams will be delivered in the order transmitted. There are various protocols, such as TCP, that attempt to guarantee packet delivery through the use of retransmissions of lost packets upon the request of the receiver. These methods do not have an obvious analogue in multicasting. At present, attempts to provide for guaranteed packet delivery using multicasting have not been very successful. In accordance with this embodiment of the invention, TTPN does not use any form of reliable multicasting but instead achieves acceptable performance using SEC. Crucial to the design of a particular implementation of SEC is the Maximum Dropout Period (MDP), the longest interval of packet dropouts that can be tolerated.

On the commodity Internet, at times of network congestion, packet loss can reach 10% or more on transcontinental routes. Unless provision is made for packet loss, each packet loss (or “dropped packet”) represents a break in the audio or video signal. Unlike the case in the unicast Transmission Control Protocol (TCP), which allows for packet recovery, the multicast transmission protocols do not attempt to retransmit dropped packets. Packet lost tends to be “bursty”, with periods of zero or low loss interspersed with periods of high, or even total, packet loss. In mathematical language, packet loss tends to be time correlated: if a packet is lost at a specific time, the probability that the next packet will be lost is higher than the probability that an arbitrarily selected packet, distant in time from that specific time, will be lost. This increased probability of additional packet losses after the loss of a packet declines with time from the event. Over a given duration, D, the packet loss can thus be statistically described in terms of a mean loss rate during that duration, ε, and a correlation time, τ, the interval over which the correlation of packet losses drops to an insignificantly low value. (Note that D must be larger than both τ and the duration between packets for this statistical description to be appropriate.)

The time-correlated nature of packet loss will tend to defeat erasure protection methods based on the simultaneous retransmission of a given stream. A simple erasure correction scheme, for example, would be to simply transmit each packet twice in a row, so that if a given packet was dropped, it could be simply replaced with the following packet. Suppose that the mean packet loss rate at a given time is 1 %, or ε=0.01. If packet losses were not time correlated, then the probability that two subsequent packets would be lost is ε², or one chance in ten thousand in this example, which might be acceptable for many applications. Since packet loss is time-correlated this scheme would be much less effective in practice. The chances that two subsequent packets would be lost might be very high, even for a mean loss rate of 1 %. If the chances that, given one packet is lost, the subsequent one is lost too is 50%, then the actual stream drop-out rate resulting from this scheme is 0.5 % in this example, only a modest improvement in performance at the cost of doubling the transmitted bandwidth.

The Staggered Erasure Correction (SEC) was designed to deal with the time-correlated nature of actual packet loss. Multiple copies of the same information are sent staggered in time, with the stagger interval being selected to be larger than a typical value for the packet loss correlation time.

In that case, the separate streams will have uncorrelated packet losses, and, for a given mean loss rate, ε, and N separate staggered streams, the total loss rate will be ε^{N}. In actual practice, a mean loss rate 10 % (or ε=0.1) represents a high rate of packet loss, and a typical value for packet loss correlation time would be 1 second. Given these parameters, the following table describes the expected performance of a SEC system:

| | | |
|---|---|---|
| Number of Staggered | Probability of | Mean Time Between |
| Channels | Packet Loss | Drop-outs |

SEC Performance: ε = 0.1

| | | |
|---|---|---|
| 1 | 10% | 10 seconds |
| 2 | 1% | 100 seconds |
| 3 | 0.1% | 1000 seconds |

SEC Performance: ε = 0.01

| | | |
|---|---|---|
| 1 | 1% | 100 seconds |
| 2 | 0.01% | 2.8 hours |
| 3 | 0.0001% | 12 days |

with a typical drop-out duration being 1 second. A SEC with three staggered streams is sufficient to reduce drop outs to the level of a few per hour under fairly extreme conditions of packet loss, and to near zero at other times, which was the MTN design goal.
Staggered Erasure Correction: Sub-Streams

In the most straight-forward SEC implementation, each staggered stream would be a full copy of the original data. The above SEC implementation, with three staggered streams, would reduce drop-outs to a few per hour, but at the cost of tripling the bandwidth required. In many cases, however, such as for entertainment and most audio and video transmissions, a degraded copy of the data stream, at a reduced bandwidth, may be an acceptable replacement for the full data rate. In audio entertainment, for example, using psycho-acoustic compression, while a bandwidth of 160 kilobits per second is required to give full sound quality, a bandwidth of 64 kilobits per second still provides acceptable stereo sound reproduction at most times, and a bandwidth of 32 kilobits per second is marginally acceptable in monaural sound reproduction. Since a stereo sound reproduction can be sent as two monaural reproductions, the staggered channels used in SEC can be one full rate channel (the main stream), which would, in conditions of no packet loss, be the source of the sound reproduction, plus two monaural channels (the sub-streams). In the case a full rate channel packet was dropped, it would be replaced by the two monaural channels, used to reproduce the stereo audio stream, while it would take the loss of both the main rate stream and one of the two sub-streams before the reproduction quality dropped to monaural. This scheme provides the same protection against dropouts as the full channel reproduction SEC, but at a cost of only a 40% increase in bandwidth required, compared to the 200% increase required by the full channel reproduction SEC.

The following table describes the expected durations of degraded signal quality in a period of high packet loss.

SEC Reproduction Quality: ε = 0.1

| Number of Staggered | Probability of | Mean Time Between | Sound | Seconds |
|---|---|---|---|---|
| Channels | Packet Loss | Drop-outs | Quality | per hour |
| 1 | 10% | 10 seconds | Full rate Stereo | 3240 |
| 2 | 1% | 100 seconds | Reduced rate Stereo | 324 |
| 3 | 0.1% | 1000 seconds | Monaural | 32 |
| | | | Drop-out | 4 |

Staggered Erasure Correction: Recombination

The SEC scheme requires recombination to recreate the original stream. In the case of a stream ordered in time, such as an audio or video stream, each packet conveys (part or all) of the signal for a given interval of time. Recombination is facilitated if these periods are the same or commensurate for each of the SEC streams. At the receiver, packets are decoded and time ordered in a separate queue for each stream. Suppose that each packet represents the signal for a time tᵢ. In the receiver, there will thus be a queue of packets for tᵢ, tᵢ₋₁, tᵢ₋₂, etc, with the possibility of missing packets from any queue. When it is time to reproduce the signal for time tᵢ, the receiver examines each queue in turn, selecting either the first queue with a packet for that time, if the queue is for a full-rate channel, or packets for as many reduced rate channels as are available. Only in the case that every queue was missing a packet for that time is there a dropout. The reconstituted stream can then be sent to other software, such as a video or audio player, for further processing; this subsequent software need not know the details of the SEC recombination process.

A TTP can implement SEC in its initial broadcasts through, for example, transmission of four separate sub-streams:
The Main sub-channel (M-channel), a joint normal stereo MP3 encoding at 160 kilobits per second (kbps), transmitted MDP/2 seconds in advance of real time (i.e., the time at which the transmissions are intended to be played).
The Immediate sub-channel (I-channel), a mono MP3 encoding at 32 kbps, transmitted 1 second in advance of real time.
The Delayed sub-channel (D-channel), a mono MP3 encoding at 32 kbps, transmitted MDP seconds in advance of real time.
The Text sub-channel (T-channel), transmitting the ASCII text required for the advertising crawl bar and any required control information, transmitted MDP/2 seconds in advance of real time at 5 kbps.
   In this example, in normal full rate operations, the M, I, D and T channels will each be separate sources of a multicast group, and all will be received by the full rate service. Since every separate multicast source is charged for, the number of multicast groups will have to be kept to a minimum. Until IGMP version 3 support is available in the network, there will have to be separate multicast groups for
G₁: Full rate service: the M channel, totaling 160 kbps.
G₂: Lower rate service: the D channels, totaling 32 kbps.
G₃: Basic service: the I-channel and T-channel, at 39 kbps.
   These multicast groups can be used to support, for example, the following services
S₁: Full rate service: the G₁, G₂ and G₃groups, totaling 229 kbps.
S₂: Lower rate service: the G₁, and G₃groups only, totaling 197 kbps.
S₃: ISDN service: using the G₂ and G₃groups only, totaling 69 kbps.
S₄: Dial-up service: using the G₃group only, totaling 39 kbps.
   In the primary usage, the receiver will select the appropriate service for its connection bandwidth.

When initially joining the transmission, the I channel information is used to provide low rate audio broadcast until all of the other channels have been received.

When changing channels, the new G₃ group is joined immediately, and playback starts after 3 seconds. At that time the other groups, if any, in the service are joined.

The SEC will require, for stereo broadcasts, encoding the following information, where L is the Left stereo channel feed and R is the Right stereo channel feed:
The M channel is the usual joint stereo
The D channel is encoded as L+R in mono.
The I channel is encoded as L−R in mono.
   When stereo is made available from the D and I channels, then the following assignments must be made:
Left=(D+I)/2
Right=(D−I)/2
   In case of a mono recording, the left and right channels will both be the mono feed.

The SEC is implemented through use of common time slices for each MP3 frame (which will consist of more than one Internet packet in general). The receiver will order the incoming frames from each group in a random access buffer. The following playback order shall be observed:
1.) For a time slice with M, D and I frames, the M frame shall be played.
2.) For a time slice with M and I frames, the M frame shall be played.
3.) For a time slice with M and D frames, the M frame shall be played.
4.) For a time slice with D and I frames only, normal stereo shall be played using the above decoding
5.) If only the D or I frame is available, mono shall be played based on the available frame.

In all cases the playback shall be in real time (i.e., 1 second after the encoding time of the I channel).

These separate groups can be used to implement Receiver-Based Congestion avoidance (WBCA) based on the amount of time the primary channel has to be replaced by lower rate information. If this occurs for more than WBCA Threshold Ratio proportion of the time in a WBCA threshold interval, the receiver shall implement WBCA. The default values for the WBCA Threshold Ratio is 50%, and for WBCA Interval is 5 minutes.

In PIM-SM v.2 a multicast group leave is supposed to be completed in no more than 3 seconds. The MTN receivers, if receiving Group Si, with i<4, can execute receiver based congestion avoidance by going from Sᵢ to service Sᵢ₊₁, by:
1.) Leaving the group, Gᵢ, with the lowest index i in Si
2.) (For service S₂ only) Waiting 3 seconds, using the previously stored SEC information to make up for any packet loss
3.) (For service S₂ only) Joining group G₂.
   This process can be repeated as needed. After a period of time, the Congestion Avoidance Wait Period (CAWP, with a default of 5 minutes), then an attempt is made to restore the previous service by going from Sᵢ₊₁, to service Sᵢ by;
1.) (For service S₃ only) Leaving group G₂.
2.) (For service S₃ only) Waiting 3 seconds, using the previously stored SEC information to make up for any packet loss
3.) Joining group Gⱼ required for service S₁

While various implementations of the inventive system and model for multicast peering, including Staggered Erasure Protection and Multicast Firewall, have been described in detail, a skilled artisan will readily appreciate that numerous other implementations, particularly those where establishing a multicast transmission is desired, are possible without departing from the spirit of the invention.

1. A method of delivering data on an Internet to a plurality of receivers, said receivers comprising first subscribers of a first independent internet service provider and second subscribers of a second independent internet service provider, said first and second independent Internet service providers being capable of providing multicast service to said first and second subscribers, respectively, said method comprising:
delivering said data to said first Internet service provider, said first Internet service provider multicasting said data, thereby making said information available to said at least one of said first subscribers; and
delivering said data to said second Internet service provider, said second Internet service provider multicasting said data, thereby making said information available to said at least one of said second subscribers.

2. The method according to claim 1, further comprising receiving a request for transmitting information to at least one of said first subscribers and at least one of said second subscribers.

3. The method according to claim 1, wherein said information comprises at least one of audio and video data.

4. A method for joining a multicast transmission on an Internet, said transmissions being multicasted to first subscribers of a first independent Internet service provider and to second subscribers of a second independent Internet service provider,
wherein said first and second independent Internet service providers are capable of providing multicast service to said first and second subscribers, respectively,
said method comprising:
sending a join request to said first independent Internet service provider, and making said multicast transmission available to at least one of said first subscribers in accordance with said join request; or
sending a join request to said second independent Internet service provider, and making said multicast transmission available to at least one of said second subscribers in accordance with said join request.

5. The method according to claim 4, wherein said join request is sent from one of said first and second subscribers.

6. The method according to claim 4, further comprising:
receiving said join request at a first router of said first independent Internet service provider;
transmitting said join request to a second router, which receives information from said first router and from a third router, if said first router is not receiving said multicast transmission;
establishing said multicast transmission on said first router if said second router is receiving said multicast transmission; and
joining said multicast transmission on said first router;
wherein said transmitting said join request and said establishing said multicast transmission are repeated until either said join request is received by a router which is receiving said multicast transmission, or until said join request is received by said source of said multicast transmission.

7. A method for delivering a multicast transmission to least one of first subscribers of a first independent Internet service provider, and to at least one of second subscribers of a second independent Internet service provider, said method comprising:
establishing a trusted third party, said trusted third party having authorization for sending said multicast transmission to said first independent internet service provider, and to said second independent internet service provider;
providing information, via said trusted third party, indicative of availability of said multicast transmission to at least one of said first and second subscribers, and providing to at least one of said first and second subscribers an indication of an action that is to be performed to receive said multicast transmission; and
delivering said multicast transmission, via said trusted third party, to at least one of said subscribers in response to said action performed by said at least one of said subscribers.

8. The method according to claim 7 wherein said trusted third party sends unicast messages indicative of said multicast transmission to each of said first and second independent internet service providers,
whereby said first independent internet service provider establishes said multicast transmission from said first router, and said second independent internet service provider establishes said multicast transmission from said second router.

9. The method according to claim 7 wherein at least one of said first and second routers is a border router.

10. The method according to claim 8 wherein said multicast transmission is delivered to a router which receives information from, and/or delivers information to, said at least one of said subscribers.

11. The method according to claim 8 wherein said unicast messages indicative of said multicast transmission are individually tailored based on the routing requirements of respective ones of said first and second independent internet service providers.

12. The method according to claim 7 wherein said trusted third party sends a multicast message indicative of said multicast transmission to said first and second independent internet service providers,
whereby said first independent internet service provider establishes said multicast transmission from said first router, and said second independent internet service provider establishes said multicast transmission from said second router.

13. The method according to claim 7 wherein delivering said multicast transmission to at least one of said subscribers is in response only to said action performed by said at least one of said subscribers.

14. The method according to claim 7 wherein said multicast transmission comprises a plurality of separate channels, each of said separate channels carrying a separate stream of information.

15. The method according to claim 14 wherein each of said separate channels comprises at least a first sub-channel and a second sub-channel, said first sub-channels carrying a first copy of said separate stream of information and said second sub-channels carrying a second copy of said separate stream of information.

16. The method according to claim 15 further comprising creating a multicast group for said plurality of said separate channels, said multicast group comprising a plurality of multicast sources.

17. The method according to claim 15 further comprising creating a plurality of multicast groups, each of said multicast groups corresponding to each of said plurality of said separate channels, and each of said multicast groups comprising a multicast source.

18. The method according to claim 15 further comprising
transmitting said first copy of said separate stream of information sources on said first sub-channel at a first time, and
transmitting said second copy of said separate stream of information on said second sub-channel at a second time,
wherein said first time is not equal to said second time.

19. The method according to claim 15 further comprising combining said first copy of said separate stream information and said second copy of said separate stream information into a combined stream of information, wherein any corrupt or missing data in one of said first copy and said second copy of said separate stream of information is replaced by a corresponding uncorrupted data from another of said first copy and said second copy of said separate stream of information.

20. The method according to claim 18 where said first copy of said separate stream of information is transmitted at lower rate than a rate of transmission of said second copy of said separate stream of information.

21. The method according to claim 18 wherein said first copy of said separate stream of information is transmitted at a lower “quality” than a quality of transmission of said second copy of said separate stream of information.

22. The method according to claim 21 wherein said second copy of said separate stream of information is transmitted at a desired “quality”.

23. The method according to claim 14 wherein said separate stream of information is audio or video data.

24. The method according to claim 20 wherein said first copy of said separate stream of information transmitted at said lower rate is sufficient to recover at least a minimal representation of said separate stream of information.

25. The method according to claim 21 wherein said first copy of said separate stream of information transmitted at said lower quality contains information sufficient to recover at least a minimal representation of said separate stream of information.

26. The method according to claim 14 comprising:
transmitting said separate stream of information on a main sub-channel as a joint normal stereo MP3 encoding at 160 kilobits per second, transmitted MDP/2 seconds in advance of real time,
transmitting said separate stream of information on an immediate sub-channel as a mono MP3 encoding at approximately 32 kbps, transmitted one second in advance of real time,
transmitting said separate stream of information on a delayed sub-channel as a mono MP3 encoding at 32 kbps, transmitted MDP seconds in advance of real time, and
transmitting ASCII text on a text sub-channel MDP/2 seconds in advance of real time at 5 kbps.

27. The method according to claim 26 wherein said ASCII text contains data for an advertising crawl bar or for any required control information,

28. A method of delivering a stream of information on an Internet, said information including a stream of data transmitted at a first time, comprising:
creating a sub-stream of data which is a copy of said stream of data; and
transmitting said sub-stream of data at a second time.

29. A method according to claim 28 wherein said second time is not equal to said first time.

30. A method according to claim 28 wherein said stream of data and said sub-stream of data are multicasted on the Internet.

31. The method according to claim 28 wherein said stream of data is audio or video data.

32. A method according to claim 28 further comprising combining said stream of data and said sub-stream of data into a combined stream of data, wherein any corrupt or missing data in one of said stream of data and said sub-stream of data is replaced by a corresponding uncorrupted data from another of said stream of data and said sub-stream of data.

33. The method according to claim 28 where said sub-stream of data is transmitted at lower rate than a rate of transmission of said stream of data.

34. The method according to claim 28 wherein said sub-stream of data is transmitted at a lower “quality” than a quality of transmission of said stream of data.

35. The method according to claim 34 wherein said stream of data is transmitted at a desired “quality”.

36. A method of delivering a stream of information on an Internet comprising:
creating at least a first sub-stream of information, which is a first copy of said stream of information, and a second sub-stream of information, which is a second copy of said stream of information;
transmitting said first sub-stream of information at a first time; and
transmitting said second sub-stream of information at a second time.

37. A method according to claim 36 wherein said first time is not equal to said second time.

38. A method according to claim 36 wherein said first sub-stream of information and said second sub-stream of information are multicasted on the Internet.

39. The method according to claim 36 wherein said stream of data is audio or video data.

40. A method according to claim 36 further comprising combining said first sub-stream of information and said second sub-stream of information into a combined stream of data, wherein any corrupt or missing data in one of said first sub-stream of information and said second sub-stream of information is replaced by a corresponding uncorrupted data from another of said first sub-stream of information and said second sub-stream of information.

41. The method according to claim 36 where said first sub-stream of information is transmitted at lower rate than a rate of transmission of said second stream of information.

42. The method according to claim 36 wherein said first sub-stream of information is transmitted at a lower “quality” than a quality of transmission of said second stream of information.

43. The method according to claim 42 wherein said second stream of data is transmitted at a desired “quality”.

44. A method of receiving a stream of information on an Internet, said information including a stream of data transmitted at a first time, comprising:
receiving said stream of data; and
receiving a sub-stream of data, which is a copy of said stream of data, transmitted at a second time.

45. A method according to claim 44 wherein said second time is not equal to said first time.

46. A method according to claim 44 wherein said stream of data and said sub-stream of data are multicasted on the Internet.

47. The method according to claim 44 wherein said stream of data is audio or video data.

48. A method according to claim 44 further comprising combining said stream of data and said sub-stream of data into a combined stream of data, wherein any corrupt or missing data in one of said stream of data and said sub-stream of data is replaced by a corresponding uncorrupted data from another of said stream of data and said sub-stream of data.

49. A method of receiving a stream of information on an Internet comprising:
receiving at least a first sub-stream of information, which is a first copy of said stream of information transmitted at a first time, and
receiving a second sub-stream of information, which is a second copy of said stream of information transmitted at a second time.

50. A method according to claim 49 wherein said first time is not equal to said second time.

51. A method according to claim 49 wherein said first sub-stream of information and said second sub-stream of information are multicasted on the Internet.

52. The method according to claim 49 wherein said stream of data is audio or video data.

53. A method according to claim 49 further comprising combining said first sub-stream of information and said second sub-stream of information into a combined stream of data, wherein any corrupt or missing data in one of said first sub-stream of information and said second sub-stream of information is replaced by a corresponding uncorrupted data from another of said first sub-stream of information and said second sub-stream of information.
